(19) United States
(12) Patent Application Publication
(10) Pub. No.: US 2014/0280582 A1
(43) Pub. Date: Sep. 18, 2014

(54) RELATIONSHIP TRACKING AND MAINTENANCE

(71) Applicant: Samsung Electronics Company, Ltd., Suwon City (KR)

(72) Inventors: William Aylesworth, Santa Clara, CA (US); Chunkwok Lee, Santa Clara, CA (US); Jeffrey Pierce, Sunnyvale, CA (US); Alan Walendowski, San Jose, CA (US)

(73) Assignee: Samsung Electronics Company, Ltd., Suwon City (KR)

(21) Appl. No.: 14/052,456

(22) Filed: Oct. 11, 2013

Related U.S. Application Data
(60) Provisional application No. 61/780,196, filed on Mar. 13, 2013.

(51) Int. Cl. H04L 12/58

(52) U.S. Cl. CPC H04L 51/36
USPC 709/204

(57) ABSTRACT

Disclosed are for aggregating communication data. Data pertaining to a plurality of users is received. A probability that a particular user of the plurality of users will likely have a future encounter with a first other user of the plurality of users based on the received data is determined. An identity of the first other user is provided. Communication content exchanged between the first other user and the particular user is also provided.

### CROSS-REFERENCE TO RELATED APPLICATIONS

This application claims the priority benefit of U.S. Provisional Patent Application Ser. No. 61/780,196, filed Mar. 13, 2013, incorporated herein by reference in its entirety.

### TECHNICAL FIELD

The present invention relates to on-line social communication. Additionally, it relates to techniques and mechanisms for tracking and maintaining such social communication.

### BACKGROUND

Social communication is a fundamental part of being human. However, we have reached a point where we are at risk of being overwhelmed by the sheer number and types of mechanisms we possess for communication: face-to-face, email, text messaging, phone calls, Facebook, Twitter, Google+, etc. As a result, researchers and technologists have started to explore mechanisms to allow users to filter and prioritize communications. However, these communication filtering and prioritizing mechanisms tend to be limited, e.g., communication management is only provided in a specific communication application, such as email.

Improved mechanisms for tracking and maintaining social communication between users would be beneficial.

### SUMMARY OF THE INVENTION

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, apparatus and methods for aggregating communication data are disclosed. Data pertaining to a plurality of users is received. A probability that a particular user of the plurality of users will likely have a future encounter with a first other user of the plurality of users based on the received data is determined. An identity of the first other user is provided. Communication content exchanged between the first other user and the particular user is also provided. Additionally, communication data pertaining to participants of past encounters may also be provided to the participants. For example, a particular user may wish to know how much time has passed since such particular user has interacted with another user. More specifically, a particular may be presented with past encounter data for other users with whom the particular user may re-establish contact so as to strengthen social ties to such other users.

These and other features of the present invention will be presented in more detail in the following specification of certain embodiments of the invention and the accompanying figures which illustrate by way of example the principles of the invention.

### BRIEF DESCRIPTION OF THE DRAWINGS

FIG. 1 is a flow chart illustrating a technique for providing communication aggregation in accordance with one embodiment of the present invention.

FIG. 2 is a screen shot of a graphic user interface for displaying information related to other users with whom a particular user is likely to have a future encounter in accordance with a specific implementation of the present invention.

FIG. 3A is a screen shot of a graphical user interface (GUI) for displaying information related to other users with whom a particular user is likely to have had a past encounter in accordance with a first embodiment of the present invention.

FIG. 3B is a screen shot of a GUI for displaying information related to other users with whom a particular user is likely to have had a past encounter in accordance with a second embodiment of the present invention.

FIG. 3C is a screen shot of a GUI for displaying information related to other users with whom a particular user is likely to have had a past encounter in accordance with a third embodiment of the present invention.

FIG. 4A is a screen shot of a graphic user interface for displaying information related to other users with whom a particular user has likely neglected to contact in accordance with a specific embodiment of the present invention.

FIG. 4B is a screen shot of a GUI for displaying information related to a selected at-risk contact with whom a particular user has likely neglected to communicate in accordance with a specific embodiment of the present invention.

FIG. 5 is a diagrammatic representation of an example computer network in which techniques of the present invention may be implemented.

FIG. 6 illustrates a typical computer system that, when appropriately configured or designed, can serve as a system of this invention.

### DETAILED DESCRIPTION

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific embodiments, it will be understood that it is not intended to limit the invention to the embodiments.

Certain embodiments provide mechanisms for users to track, maintain, and improve social relationships across various communication channels by analyzing the user's communication patterns, scheduled interactions, and potentially face-to-face interactions. FIG. 1 is a flow chart illustrating various techniques 10 for providing communication aggregation in accordance with one embodiment of the present invention. Initially, data pertaining to a plurality of users may be received in operation 12. This received data may pertain to any suitable data that may be used to determine whether a particular user will likely have or has likely had an encounter with one or more other users.

An identity of a first other user and communication content exchanged between this first other user and a particular user may be provided if it is determined that the particular user will likely have (or not likely have) a future encounter with the first other user in operation 14. For instance, it may be determined that the particular user will more than likely have a physical encounter with a first other user in the near future, e.g., later the same day, based on the received data. Alternatively, the encounter may be virtual (e.g., an audio or video conference), rather than physical. In one example, a view of recent communication content (e.g., email messages, Facebook updates, tweets) from this first other user, with whom the particular user will likely encounter soon, is provided. This view allows users to identify recent communication content that may be relevant to impending encounters with other people. For example, communication content from another user prior to an impending encounter with a particular user may provide this particular user with talking points for use in conversation with this other user during their impending encounter (e.g., later that day). Alternatively, the particular user may be presented with identities and communication content for other users whom the particular user is not likely to encounter, for example, in a particular day or other time period.

An identity of a second user (who may be identical to or differ from the first other user) and communication content, which is exchanged between the particular user and the second other user after a past encounter has occurred, may also be provided if it is determined that the particular user likely had a past encounter with the second other in operation 16. In this embodiment, communication content from the second other user, with whom the particular user has likely met recently, may specify a topic that is related to this recent encounter (e.g., earlier that day) between the particular user and the second other user.

In an alternative embodiments, the identities and/or communication content of all the particular user's contacts for whom it is determined that the particular user is not likely to have had a past encounter and/or will likely have a future encounter. This provided content may allow the particular user to catch up on the activities of other users. The particular user may find it useful to know more about users who the particular user have not had a recent encounter or are likely to have a future encounter. In contrast, the particular user may already know (or will soon know) about activities of the users with whom the particular user has already interacted and not desire to view communication content from such encountered users.

A probability that a particular user has encountered one or more other users may be determined or updated based on proximity detection, calendar, and/or feedback data that is obtained for such particular user. Other types of data (in additional or alternatively to proximity, calendar, or feedback data) may be used in determining a future meeting probability as described further herein. A future meeting probability may also optionally be determined only for the users who are defined as having a connection to the particular user, such as users who are identified in the particular user's contact list, social trace network list, or calendar events.

Proximity detection, calendar, feedback, or any other data may be obtained from any suitable source and across multiple communication channels. Data may be obtained from accessible application databases, received from the user, or obtained from the user's device. Communication channels may take any suitable form for two or more users to communicate, such as email, texts, phone call, audio or video chat, social network, and calendar applications.

Proximity detection data may include any information that indicates the particular's user's location with respect to another user. By way of specific examples, proximity detection data may indicate the absolute or approximate locations of the particular user and other users or indicate a relative location between the particular user and other users. For instance, proximity data may take the form of GPS (global positioning satellites) data for identifying a user's physical location with respect to one or more other users, data pertaining to whether users are using a same network access point, a physical device's proximity detection data (e.g., Bluetooth) for detecting whether another user's physical device is located nearby, social check-in data (e.g., Foursquare), etc. Proximity data may also be determined from images near the user's location, such as analysis of images captured by cameras that are near a user's location.

Calendar data may also be used to determine or update a probability that a particular user will have a future encounter with another user or a probability that the particular user has had a past encounter with another user. For instance, calendar data of a particular person may include scheduled appointments or meetings with specific people or at specific locations. For instance, certain calendar applications include techniques for inviting others to a meeting, a calendar appointment field to specify who is attending a particular meeting, or a calendar location field to specify the meeting's location. Calendar data from other users who are defined as being associated with the particular user may also be obtained. For instance, the particular user's contact lists from various calendar/address applications may be used to then obtain calendar data from users in the particular user's contacts lists.

Feedback data from the particular user regarding any factor that may affect an encounter probability determination or communication aggregation technique described herein may also be obtained. Feedback data may specify whether the particular user has verified or denied that he/she is having a future encounter with one or more other users, whether he/she has actually had a past encounter with one or more other users, whether the particular user wishes to be presented with communication content for users with whom the particular user is likely to have a future encounter or to have had a past encounter, types of communication content to present or filter, whether the particular user wishes to receive reminders to contact certain other users, etc. Feedback data may also take the form of a user's absence of an action, such as ignoring a suggestion to contact a particular other user.

A model for determining the probability of whether another user is likely to have a future encounter with the particular user may be based on in any suitable factors pertaining to the other user, such as how recently the particular user has communicated with (or encountered) the other user, the frequency of communication with the other person, the type of relationship or ranking of the other user with respect to the particular user (as defined by the particular user or automatically determined based on other factors obtained through communication or social trace channels), how much or how frequently a user shares data, such as photos, with a particular other user, etc.

The likelihood of encountering a particular user on any day may be determined generally based on previous encounter data. In other examples, the likelihood of encountering the particular user on a day may be based on previous encounter data. A particular encounter day may be a weekday, weekend day, or more specific day, like Tuesday.

A specific type of encounter is a scheduled meeting. The probability for a particular user attending a repeating, scheduled meeting may be based on previous data about the particular user's attendance pattern for the meeting. In another example, the likelihood of a particular user visiting a particular location where the user is likely to encounter the other person may be based on the user's location patterns on previous (similar) days, or whether the user's calendar makes it likely that the user will need to deviate from previous location patterns (e.g., the user is traveling, so unlikely to visit the office).

Besides determining encounter probability for a particular user based on such particular user's behavior, probability may also be based or updated based on data about other users. For example, if the particular user receives a vacation notice from another user, it may be determined that the particular user is unlikely to encounter such other user (unless the users are vacationing together).

By way of specific example, a probability for encountering another user may be set relatively high when the particular user's calendar specifies a meeting with the other user or the particular user has had a relatively consistent pattern of encounters with the other user, e.g., an encounter occurs each week, month, year, or any other time period.

A probability for encountering another user may also be based on whether the other user has only a scheduled meeting with the particular user, has a consistent pattern of encounters with the particular user at a particular day or time, or both a scheduled meeting and a consistent encounter pattern. For instance, a probability for a future encounter would be higher for a first user who has both a scheduled encounter and a consistent encounter pattern at the same scheduled time with the particular user than a second user who only has a scheduled meeting. The probability that is determined for this second user may also be higher than a future encounter probability for a third user who only has a consistent encounter pattern with the particular user. Future encounter probability for a user that has a longer consistent encounter pattern (e.g., a user has a meeting with the particular user every Tues. at 8 am for 1 year) may be determined to be higher than a probability of a user with a shorter consistent encounter pattern (e.g., a user has a meeting with the particular user every Wed. at 10 am for 2 weeks).

An encounter pattern for a pair of users may be determined based on previously modeled behavior, as well as feedback from either of the users regarding actual past (or future) encounters between the pair of users. Feedback may take the form of a user's actual action, such as responding to a suggestion, or a user's absence of a particular action, such as ignoring a suggestion. In a first example, a pattern of encounters are all merely predicted to have occurred between the particular user and another user without user confirmation. For instance, an encounter pattern may be based on encounters that each have a probability calculated that is above a predefined value (e.g., more than 50%). In a second example, each predicted encounter for a particular set of one or more users may be also verified by one or more users of the predicted encounter. An unverified predicted encounter may be filtered from being used to form part of an encounter pattern for the users of the predicted encounter.

The probability of whether the particular user has had a past encounter with another user may similarly be determined. In an additional example, if proximity detection data or access point data indicates that another user is located near (or within a predefined distance) of the particular user, the probability may be determined to be higher when the other user has a corresponding scheduled meeting in the particular user's calendar data, as compared to a probability of an unscheduled, proximate user. For instance, users may be near each other, but not really interacting with each other. In a specific example, two users in two different rooms may be accessing the same wireless access point.

A probability of a future or past encounter with another user may also be determined based on a classification of the other user's social connection to the particular user. For instance, a probability of encounter with another user may be adjusted negatively or positively depending on whether the other user is family, a close friend, a work colleague (at the same or different work location, in the same or different department or group, etc.), acquaintance, belongs to the same social or professional group as the particular user, etc. A user classification may be specified by a user, e.g., interest or group membership that is specified for a particular user in a social traces application, such as Twitter or Facebook). A user classification may also be based on user behavior, such as interactions between users, that is specified from data obtained through any communication application, such as a social networking application, an email application, a video or audio chat application, texting application, etc.

For instance, a higher probability may be determined for work colleagues who are from different geographical locations of the same company and are detected to have moved in proximity of each other, as compared to work colleagues at the same location and who are detected to have moved in proximity to each other. The later example may simply mean that the two colleagues are working near each other, but not interacting.

Predicted future or past encounter information may be caused to be displayed to the particular user, e.g., via a graphical user interface (GUI) of a display of the particular user's computing device. FIG. 2 is a screen shot of a graphical user interface (GUI) 200 for displaying information related to other users with whom a particular user is likely to have a future encounter in accordance with a specific implementation of the present invention. As shown, four users (e.g., 202a and 202b), with whom a particular user has a determined probability of meeting, are shown in the GUI 200, for example, on a display of the particular user's smartphone or tablet.

All or a subset of the other users for whom a probability of meeting has been determined may be provided. In one implementation, all the other users who have been determined to have any probability of meeting with the particular user are displayed. In another implementation, only a predefined number of users with the highest meeting probability are displayed without displaying users having lower probabilities. Alternatively, users who have a future meeting probability above a predefined threshold, such as above 30% or 50%, may only be provided so as to present only the other users whom the particular user is most likely to meet.

In the illustrated embodiment, each user is identified with a photograph. However, any user identification, such as a real name or user name, may be shown to the particular user. The probability value for each identified user may also be provided (e.g., 91% likely, 45% likely, 32% likely, and 9% likely). Communication content for a selected identified user may also be displayed. As shown, the communication content 204 of a social networking update 206 and text message 208 from user “John Peters” are displayed after clicking on the photograph 202b of John Peters.

As shown in FIG. 2, a feedback mechanism 210 is displayed for the selected user John Peters, which allows the user to confirm the future encounter with John Peters will occur by selecting a “yes” button or deny that the future encounter will occur by selecting a “no” button. A feedback mechanism may be displayed with respect to any other provided encounter or communication content information that is described herein.

FIG. 3A is a screen shot of a GUI 300 for displaying information related to other users with whom a particular user is likely to have had a past encounter in accordance with a first embodiment of the present invention. As illustrated, other users with whom a particular user may have had past encounters may be displayed in a timeline format 302. Each encounter's duration (e.g., 304a, 304b, and 304c) may also be shown on the timeline 302 so that the particular user can easily view how busy his/her day was.

When a particular past encounter is selected, encounter details 306 may also be displayed. For instance, the location (Starbucks Coffee, Market Street, SF), an identity of the person (Michael), map, and encounter duration (4:15 pm-5:02 pm) may be shown. A feedback mechanism (not shown) may also be provided for each person who may have been encountered so the particular user can confirm or deny each encounter as actually occurring.

FIG. 3B is a screen shot of a GUI 320 for displaying information related to other users with whom a particular user is likely to have had a past encounter in accordance with a second embodiment of the present invention. In this example, a list of other users (e.g., 322) who the particular user may have encountered is provided. As shown, the user list is provided in the form of user photographs although other forms of user identification may be provided.

FIG. 3C is a screen shot of a GUI 340 for displaying information related to other users with whom a particular user is likely to have had a past encounter in accordance with a third embodiment of the present invention. In this example, likely past encounters are grouped by location. As shown, past encounters with users 344a and 344b are listed as likely occurring at work (342a), while other encounters are listed as likely occurring with respect to a conference room (342b) and Starbucks (342c). In this example, a user identity and probability value is provided with each potential encounter. A feedback mechanism (not shown) may also be provided.

Communication content for a particular user of a past encounter may also be displayed. For example, if a particular past encounter provided in FIGS. 3A-3C is selected, communication content related to the selected past encountered user may be displayed similar to what's shown in FIG. 2 with respect to a selected likely future encounter. The communication content may be provided only for encounters occurring within a predefined time duration after the associated past encounter so that the particular may see if there is any communication content related to their past encounter.

Referring back to FIG. 1, an identity and communication content of a third other user may also be provided if it is determined that the particular user has likely neglected the other third user, for example, in a predefined time period in operation 18. In one embodiment, the most recent communication content pertaining to the third user that the particular user has not likely encountered may also be provided to the particular user. The most recent communication context pertaining to such possibly neglected third user may also be presented to the particular user. This view may help the particular user maintain social ties to these other users by becoming more aware of which other users with whom the particular user is at-risk of severing or weakening social ties.

The predefined time period, in which it may be determined that the particular user has an absence of encounters, may be any suitable time frame. For instance, the other users whom the particular user has not encountered in the current day may be identified. In other examples, the particular user may be presented with a list of other users whom have not been encountered within a longer time period, such as a month or a year.

In another example, other users who were scheduled to encounter the particular user in a meeting, but who have failed to attend the meeting, may be tagged or identified as possibly neglected users. In one implementation, a scheduled meeting location, time, and a list of attendee users may be determined based on calendar data for such user attendees, and proximity data for the scheduled meeting location may be collected during the meeting time. Based on such collected data, scheduled other users for whom proximity data for the scheduled meeting location is absent may be identified as neglected users.

A suggestion that the particular user re-establish communication with this third other and a mechanism for re-establishing communication may also be provided in operation 18. For instance, the particular user may be presented with a list of actions that the particular user can take to re-establish communication with one or more of these at-risk other users.

FIG. 4A is a screen shot of a GUI 400 for displaying information related to at-risk social contacts with whom a particular user has likely neglected to communicate in accordance with a specific embodiment of the present invention. As shown, a list of contacts 402a, 402b, 402c, and 402d may be displayed as “people you haven't contacted for a while.” The particular user may select one of these displayed at-risk contacts to say “Hi”, which may initiate a list of selectable communication application, such as a text message, email, social network message, etc.

FIG. 4B is a screen shot of a GUI 420 for displaying information related to a selected at-risk contact with whom a particular user has likely neglected to communicate in accordance with a specific embodiment of the present invention. For example, information for user “Jane” who the particular user has selected from the list of at-risk contacts, 402a of FIG. 4A. This at-risk social contact information includes selectable actions for re-establishing communication by sending a text message (422a), making a phone call (422b), or buying a gift (422c). Other actions (e.g., sharing a photo, sending a social network private or public message/post, sending a calendar invite, initiating a video chat, etc.) may be provided. If the particular user selects one of these actions, the corresponding action may be automatically initiated with the selected at-risk social contact (e.g., a new text message is opened or a phone call is placed to the particular at-risk social contact on the user's mobile device).

At-risk social contact information may also include information for past communication between the particular user and the particular at-risk social contact. As shown, a bar chart 424 of the last communications with respect to time is shown. The content 426 of a subset of these last communications may also be provided. In the illustrated example, the last three communications (2 Facebook messages and a text message) are shown.

An at-risk social contact may be provided by first determining a probability that the user has neglected to have a past encounter with such contact within a predetermined timeframe and determining whether the contact is a candidate for suggesting that the particular user re-establish communication with such contact. An at-risk contact may be determined based on any suitable data, such as social traces, encounter, and feedback data. In general, contacts of the particular user may be determined to be at-risk when communication across multiple communication channels has fallen off between the particular user and the at-risk contact by a certain amount or other factor. That is, contacts may be defined as at-risk for users with whom a particular user has not communicated or interacted in any way over a predefined duration of time (e.g., more than 3 months). Interactions may be tracked across multiple communication channels, including email, texting, phone calls, social networks, calendars, proximity detection, etc.

In a specific example, a social contact may be identified as at-risk when the counts of communication interactions for a particular time period fall below a predefined count. For instance, a count is maintained for each period of 7 days. When the communication count for the most recent 7 days falls below a predetermined threshold, the associated user is deemed to be at risk. In a related example, when the communication count between two consecutive time periods decreases by a predefined amount, the associated user is deemed to be at risk. To illustrate, a particular user may communicate the following number of times with another user for each of 6 weeks: 7, 6, 5, 7, 5, 1. The difference in communication number is −4 between the last week and the second-to-last week, which is a sharper adjustment than the count differences between the previous weeks (difference of −1, −1, +2, and −2).

In another example, each contact is given a particular value or count for each communication with the particular user and this value/count starts to decrease when communication stops. When the value/count falls below a predefined threshold, the associated social contact is deemed at-risk.

Users who have relatively low communications counts with the particular user for a long period of time, as compared to other users, may also be filtered out of the at-risk determinations. Counting may recommence for these filtered out users if their counts remain above a predetermined threshold for a particular amount of time. This threshold may be based on an average count for the particular user's contacts.

At-risk thresholds may vary based on user classification. The particular user can classify his/her social contacts into different levels of communication frequency groups. For instance, close friends may have a higher communication count threshold for being at-risk than mere acquaintances. Social contacts may also be automatically classified based on past communication quantity and/or frequency and/or user feedback about wanting to contact such other user.

Determining whether a particular user should be notified of at-risk social contacts may be temporarily stopped based on the particular user's overall activity. For example, if the particular user is on vacation, reminders of at-risk contacts may be blocked during the vacation. Additionally, notification of at-risk social contacts may be based on user feedback. For instance, the particular user may specify that they do not wish to temporarily or permanently receive at-risk contact notifications (or communication reminders) for certain users.

User behavior feedback data may be used to indicate a need for decreasing or increasing communication between users. For instance, user A may provide feedback about wanting to contact or wanting to stop contact with user B, and this feedback is then used to adjust the amount or frequency of defining user B as an at-risk candidate and suggesting that user A reestablish communication with user B. If user A does not want to receive notifications about user B being at-risk, then at-risk notifications for user B may be triggered and sent to user A after a higher communication count threshold. User B may also be provided with a signal indicating user A is not interested in more frequent contact. Additionally, user B may be notified that user A is at-risk at a higher threshold. That is, feedback from user A may affect notifications sent to both him/herself and user B. Likewise, if user A gives feedback that user A wants to contact user B, at-risk notifications about user B being at-risk may be triggered and sent to user A after a lower communication count threshold is reached. User B may also be provided with a signal indicating user A wants to have more frequent contact. Additionally, user B may be notified that user A is at-risk at a lower threshold.

Referring back to FIG. 1, a user feedback mechanism may also be provided along with any of the provided identity of the first, second, or third user in operation 20. The feedback may relate to factors for determining likelihood of future or past encounters between the particular user and any of these other users and whether to present suggestions for the particular user to re-establish communication with other users. One or more probability determinations regarding future or past encounters or whether to suggest re-establishing communication may be updated based on any feedback received from the particular user regarding the first, second, or third other user in operation 22.

Feedback from a particular user may be collected over time and with respect to the same or different users. For example, the particular user can confirm that he/she had actual meetings once a week with a specific other user over a period of several months.

The feedback data may also pertain to users if such users are determined to be “at-risk” users, with whom the particular user is at risk of losing contact. In specific examples, feedback data may indicate whether the particular user wishes to be reminded to contact all or individual at-risk users, whether the particular user wishes to be presented with mechanisms for re-establishing contact with all or individual at-risk users, etc.

Any of the above described operations for determining likely past or future encounters or at-risk social contacts may be repeated for any number of other users (both the same and different users) in any suitable order for a particular user. Additionally, the techniques for determining past or future encounters may also be based on any of the factors used for determining at-risk social contacts or whether an associated user has been deemed at-risk.

Any of the above operations may be triggered by any suitable event, such as expiration of a time period or receipt of a user request. Likely past or future encounters may be identified at particular times. For example, likely future encounters may be provided at the start of each day, while past encounters are provided at the end of each day. Identification of encounters or at-risk social contacts may also be provided based on the particular user's pattern of social interactions. For example, certain user behavior may indicate that the user is more amenable to being interrupted by presentation of encounter or at-risk information (e.g., the user has down time while traveling on public transportation).

Suggestions for re-establishing contact may also be customized based on user behavior. For instance, a user that has taken a photograph may be presented with a selectable option to share such photograph to an at-risk social contact or user whom he/she has a past or future encounter. Similar sharing type actions may also be suggested for any behavior by the particular user that may be interesting to certain social contacts, regardless of the contacts being deemed as at-risk.

Embodiments of the present invention may be implemented in any suitable network environment. FIG. 5 is a diagrammatic representation of a simplified network environment 500 in which techniques of the present invention may be implemented. The network system may include any number and type of client devices (e.g., 502a, 502b, and 502c) that are configured to allow users of such client devices to communicate with each other through various communication channels over a wide area or local area computer network 506. The client devices may also be configured to communicate via a wireless network (or access point) 503.

A client device may be a portable device, such as a laptop or tablet (502a) or cell phone (502b). One or more proximity detection systems 514 may track location or proximity of such mobile devices. One or more proximity databases 516 for storing proximity data may be associated with each proximity detection system 514.

The network 500 may also include one or more calendar and contacts systems 510 for tracking and maintaining scheduled meetings and contacts lists for a plurality of users. One or more calendar and contacts databases 512 for storing calendar and user contact information may also be associated with each calendar and contacts system 510.

Each client device may also be configured to interact with one or more social traces systems 518. One or more social traces databases 520 for storing social trace data may be associated with each social trace system 518.

A communication aggregation system 504 may be configured to provide likely encounter and at-risk social contact information to one or more users, for example, to their respective client devices. The communication aggregation system may include a network interface 550 for obtaining data from any number of data repositories and devices via a network 506 and storing communication data in one or more communication databases 507. The communication aggregation system 504 may also include a communication aggregation circuit 508 for determining probabilities of likely past and future encounters and at-risk based on this obtained data.

The network 506 may take any suitable form, such as a wide area network or Internet and/or one or more local area networks (LAN's). The network may be in the form of a data, mobile, cellular, plain old telephone network (POTN), or any combination thereof. The network 506 may include any suitable number and type of devices, e.g., routers and switches, for forwarding requests from each client to a particular server application, forwarding application results back to the requesting clients, or forwarding data between various servers.

Embodiments of the present invention may also be practiced in a wide variety of network environments (represented by network 506) including, for example, TCP/IP-based networks (e.g., Rate Control Protocol or RCP, Transport Control Protocol or TCP, Fast TCP, Stream-based TCP/IP or STCP, eXplicit Control Protocol or XCP, etc.), telecommunications networks, wireless networks, mobile networks, etc., or any combination thereof. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be affected or employed at different locations.

The disclosed techniques of the present invention may be implemented in any suitable combination of software and/or hardware systems, such as a web-based server. The apparatus may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

FIG. 6 illustrates a typical computer system that, when appropriately configured or designed, can serve as communication aggregation system. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers and microprocessors such as programmable devices (e.g., CPLDs and FPGAs) and unprogrammable devices such as gate array ASICs or general-purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable computer-readable media such as those described herein. A mass storage device 608 is also coupled bi-directionally to CPU 602 and provides additional data storage capacity and may include any of the computer-readable media described herein. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 is also coupled to an interface 610 that connects to one or more input/output devices such as video monitors or displays, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications network using an external connection as shown generally at 612. With such a connection, it is contemplated that the CPU might receive information from the network, or might output information to the network in the course of performing the method steps described herein. CPU 602 may also be coupled with any other suitable internal devices, such as a NFC device.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

A network may also include mass storage, such as network attached storage (NAS), a storage area network (SAN), or other forms of computer or machine readable storage media, for example. Regardless of the system's configuration (e.g., client or server), it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the present invention relates to machine readable storage media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that are specially configured to store and perform program instructions, such as ROM and RAM. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A device comprising:
a network interface configured to receive data pertaining to a plurality of users; and
a communication aggregation circuit, coupled to the network interface, configured for:
determining a first probability that a particular user of the plurality of users will likely have a future encounter with a first other user of the plurality of users based on the received data;
providing an identity of the first other user; and
providing communication content exchanged between the first other user and the particular user.

2. The device of claim 1, wherein the first probability that the particular user will likely have a future encounter with the first other user is determined by analyzing a pattern over time of past encounters between the particular user and the first other user.

3. The device of claim 1, wherein the aggregation circuit is further configured to perform the following:
determining a second probability that the particular user likely had a past encounter with a second other user of the plurality of users based on the received data; and
if the second probability indicates that the particular user likely had a past encounter with the second other user, providing an identity of the second other user and an identity of the past encounter.

4. The device of claim 3, wherein the aggregation circuit is further configured to perform the following:
in association with the second other user for whom the second probability indicates that the particular user likely had a past encounter with the second other user, providing communication content exchanged between the second other user and the particular user.

5. The device of claim 4, wherein the communication content exchanged between the second other user and the particular user is generated from a plurality of communication channels comprising an email application, a texting application, and a social communication application.

6. The device of claim 3, wherein the second probability that the particular user likely had a past encounter with the second other user is determined by analyzing a pattern of encounters over time.

7. The device of claim 3, wherein the device is in a form of a server system and the communication content and identities of the first and second other user are provided by the server system to the display of a personal communication device of the particular user.

8. The device of claim 1, wherein the received data comprises calendar data and proximity detection data and the first probability that the particular user will likely have the future encounter with the first user is determined based on the calendar data and proximity detection data.

9. The device of claim 8, wherein the received data comprises interaction data, including social trace data, pertaining to the particular user and other users of the plurality of users; and the aggregation circuit is further configured to perform the following:
determining a third probability that the particular user has neglected to have a past encounter with the second other user of the plurality of users based on the received calendar data, proximity detection data, and interaction data;
if the third probability indicates that the particular user has likely neglected to have a past encounter with the second other user, determining whether the second other user is a candidate for suggesting that the particular user re-establish contact with the second other user; and
for the second other user that is determined to be a candidate, providing an identity of the second other user and an indication that the particular user has not had a recent encounter with the candidate.

10. The device of claim 9, wherein the aggregation circuit is further configured to perform the following:
for the second other user that is determined to be a candidate, providing an indication as to how much time has passed since the particular user has had one or more past encounters with the second other user and an indication of a type of each one or more past encounters,
wherein the determination of whether the second other user is a candidate is based on how recently the particular user communicated with the second other user and how frequently the particular user communicated with the second other user.

11. The device of claim 10, wherein the aggregation circuit is further configured to perform the following:
for the second other user that is determined to be a candidate, providing a plurality of actions for re-establishing contact with the second other user; and
for the second other user that is determined to be a candidate, upon selection of a particular one of the plurality of actions, initiating the particular action.

12. The device of claim 11, wherein the actions comprise sending a text message and placing a phone call.

13. The device of claim 11, wherein the actions further comprise sending a calendar invite and posting a social trace update.

14. The device of claim 11, wherein the determination of whether the second other user is a candidate is further based on feedback that was previously received from the particular user in response to a previously provided action for re-establishing contact with the second other user.

15. The device of claim 10, wherein the determination of whether the second other user is a candidate is further based on whether a count of past encounters between the particular user and the second other user decreases below a predefined threshold.

16. The device of claim 10, wherein the determination of whether the second other user is a candidate is further based on whether a derivative of a number of past encounters between the particular user and the second other user decreases below a predefined threshold.

17. The device of claim 10, wherein the determination of whether the second other user is a candidate is further based on a category of the second other user.

18. The device of claim 9, wherein the interaction data, upon which the probability that the particular user has likely neglected to have a past encounter with the second other user is based, further comprises email, text, and phone communication data.

19. The device of claim 9, wherein determining whether the second other user is a candidate is based on assigning a plurality of scores to each of the plurality of other users who are contacts of the particular user, wherein the scores are based on one or more factors obtained from past communication between the particular user and the contact.

20. The device of claim 1, wherein the communication content was sent from the first other user prior to the future encounter actually occurring between the particular user and the first other user, wherein the communication aggregation circuit is further configured to provide another communication content that is exchanged after the future encounter actually occurs between the particular user and the first other user.

21. The device of claim 1, wherein the communication content includes two or more of the following types of communication generated by either the particular user or the first other user: an email message, a text message, a social network update, or a tweet update.

22. A graphical user interface produced by and displayed on a display of a computing device, the graphical user interface comprising:
a first section configured to display an identity for each of one or more first contacts of a particular user and an indication that the each first contact will likely have a future encounter with the particular user; and
a second section configured to present communication content for each displayed identity of each first contact, wherein the communication content was exchanged between the first contact and the particular user.

23. The graphical user interface of claim 22, further comprising:
a third section configured to present an identity of each of one or more second contacts of the particular user, for which it is determined that the particular user likely had a past encounter with the second contact and an identity of the past encounter.

24. The graphical user interface of claim 23, further comprising:
a fourth section configured to present, in association with each second contact identity, communication content that was exchanged between the second contact and the particular user.

25. The graphical user interface of claim 24, further comprising:
a fifth section configured to present an identity of each of one or more third contacts of the particular user with whom the particular user has not had a recent encounter and to present, in association with each of the one or more third contacts, an indication as to how much time has passed since the particular user has had one or more past encounters with the each third contact and an indication of a type of each one or more past encounters; and
a sixth section configured to present a plurality of selectable actions for re-establishing contact with each of the one or more third contacts.

26. A method comprising:
receiving data pertaining to a plurality of users;
determining, using a processor, a probability that a particular user of the plurality of users will likely have a future encounter with a first other user of the plurality of users based on the received data;
providing an identity of the first other user; and
providing communication content exchanged between the first other user and the particular user.

27. At least one computer readable storage medium having computer program instructions stored thereon that are arranged to perform the following operations:
receiving data pertaining to a plurality of users over a network interface of a device;
determining a probability that a particular user of the plurality of users will likely have a future encounter with a first other user of the plurality of users based on the received data;
for the first other user who will likely have the future encounter with the particular user, providing an identity of the first other user; and
at a device, providing communication content received by the particular user, wherein the communication content was sent from the first other user or sent from the particular user to the first other user.

28. An apparatus comprising a network interface, one or more processors, and one or more memory, wherein the one or more processor and/or memory are configured to perform the following operations:
receiving data pertaining to a plurality of users over the network interface;
determining a probability that a particular user of the plurality of users will likely have a future encounter with a first other user of the plurality of users based on the received data;
for the first other user who will likely have the future encounter with the particular user, providing an identity of the first other user; and
providing communication content received by the particular user, wherein the communication content was sent from the first other user or sent from the particular user to the first other user.
